(19) United States
(12) Patent Application Publication
(10) Pub. No.: US 2026/0285187 A1
(43) Pub. Date: Sep. 24, 2026

(54) PAYMENT TERMINAL WITH UWB-BASED VEHICLE DETECTION AND COMMUNICATION

(71) Applicant: VeriFone, Inc., Wilmington, DE (US)

(72) Inventor: Santhosh Gillella, Wilmington, DE (US)

(73) Assignee: VeriFone, Inc., Wilmington, DE (US)

(21) Appl. No.: 19/168,630

(22) PCT Filed: Mar. 24, 2023
(86) PCT No.: PCT/US2023/016256

§ 371 Date: Sep. 24, 2025

(51) Int. Cl. B60L 53/66; G06Q 20/14; G06Q 20/18; G06Q 20/32; G06Q 20/40

(52) U.S. Cl. CPC B60L 53/665; G06Q 20/18; G06Q 20/3224; G06Q 20/327; G06Q 20/4014; G06Q 20/4015; G06Q 20/145

(57) ABSTRACT

A fuel dispenser payment terminal, includes: an ultra-wideband transceiver; and a controller in communication with the ultra-wideband transceiver and with a fuel dispenser, the controller being programmed to: receive, via the ultra-wideband transceiver, a vehicle UWB signal from a vehicle ultra-wideband tag disposed on a vehicle; determine from the vehicle UWB signal a location of the vehicle and a fuel type associated with the vehicle; and authorize the fuel dispenser to dispense the fuel type associated with the vehicle, based, at least in part, on whether the location of the vehicle is within a predetermined fueling location.

### BACKGROUND

At self-serve gas or charge stations, before beginning the fueling or charging process, users need to, each time, exit the vehicle, tap/insert a payment card or device and select fuel or charge type. As part of this process, user sometimes (e.g., where the user has rented the vehicle) do not know recommended type of fuel or charge type for the vehicle. For example, certain types of vehicles need premium gasoline, such as with 93 octane fuel.

In addition, if a user drives away from the fuel dispenser or charger without returning the nozzle or plug to its base, the transaction will not be completed, allowing others to potentially use the fuel dispenser or charge station at the expense of the original user. Further, a user that is part of a merchant program that provides rewards or discounted fuel/charging, can use the user's membership to permit non-members to use the fuel dispenser or charger by entering the membership information and beginning the transaction without returning the nozzle or plug to its base. This can, intentionally or otherwise, allow non-members to abuse the fueling or charging programs offered to members of the merchant program.

### SUMMARY

According to an aspect, a fuel dispenser payment terminal, includes: an ultra-wideband transceiver; and a controller in communication with the ultra-wideband transceiver and with a fuel dispenser, the controller being programmed to: receive, via the ultra-wideband transceiver, a vehicle UWB signal from a vehicle ultra-wideband tag disposed on a vehicle; determine from the vehicle UWB signal a location of the vehicle and a fuel type associated with the vehicle; and authorize the fuel dispenser to dispense the fuel type associated with the vehicle, based, at least in part, on whether the location of the vehicle is within a predetermined fueling location.

In an example, the controller is further programmed to: monitor the location of the vehicle according to the vehicle UWB signal and to deauthorize the fuel dispenser if the location of the vehicle changes.

In an example, authorizing the fuel dispenser to dispense the fuel type associated with the vehicle is further based on determining whether the vehicle UWB signal is associated with a user authorized to receive fuel from the fuel dispenser.

In an example, authorizing the fuel dispenser to dispense the fuel type associated with the vehicle is further based on receiving payment information in the vehicle UWB signal.

In an example, authorizing the fuel dispenser to dispense the fuel type associated with the vehicle is further based on receiving payment information from a user.

In an example, determining from the vehicle UWB signal a fuel type associated with the vehicle comprises determining from the vehicle UWB signal a vehicle type encoded in the vehicle UWB signal, sending the vehicle type to a remote server, and receiving, from the remote server, the fuel type associated with the vehicle.

In an example, the controller is further programmed to: receive, in the vehicle UWB signal, an indication of whether the vehicle engine is stopped or running and prompt a user to turn off the engine if the engine is running.

In an example, prompting the user to turn off the engine comprises displaying a message on a screen visible to a user.

In an example, authorizing the fuel dispenser to dispense the fuel type associated with the vehicle is further based on receiving, in the vehicle UWB signal, the indication that the vehicle engine is stopped.

In an example, the controller is further programmed to: receive, in the vehicle UWB signal, an indication of an amount of fuel the vehicle can receive, wherein, the fuel dispenser is authorized to dispense only the amount of fuel indicated in the vehicle UWB signal.

According to another aspect, a method for authorizing fuel dispensation, includes: receiving, via an ultra-wideband transceiver, a vehicle UWB signal from a vehicle ultra-wideband transceiver disposed within a vehicle; determining from the vehicle UWB signal a location of the vehicle and a fuel type associated with the vehicle; and authorizing a fuel dispenser to dispense the fuel type associated with the vehicle, based, at least in part, on whether the location of the vehicle is within a predetermined fueling location.

In an example, the method further includes: monitoring the location of the vehicle according to the vehicle UWB signal and to deauthorize the fuel dispenser if the location of the vehicle changes.

In an example, authorizing the fuel dispenser to dispense the fuel type associated with the vehicle is further based on determining whether the vehicle UWB signal is associated with a user authorized to receive fuel from the fuel dispenser.

In an example, authorizing the fuel dispenser to dispense the fuel type associated with the vehicle is further based on receiving payment information in the vehicle UWB signal.

In an example, authorizing the fuel dispenser to dispense the fuel type associated with the vehicle is further based on receiving payment information from a user.

In an example, the method further includes determining from the vehicle UWB signal a fuel type associated with the vehicle comprises determining from the vehicle UWB signal a vehicle type encoded in the vehicle UWB signal, sending the vehicle type to a remote server, and receiving, from the remote server, the fuel type associated with the vehicle.

In an example, the method further includes: receiving, in the vehicle UWB signal, an indication of whether the vehicle engine is stopped or running and prompting a user to turn off the engine upon determining the engine is running.

In an example, the method further includes prompting the user to turn off the engine comprises displaying a message on a screen visible to a user.

In an example, authorizing the fuel dispenser to dispense the fuel type associated with the vehicle is further based on receiving, in the vehicle UWB signal, the indication that the vehicle engine is stopped.

In an example, the method further includes receiving, in the vehicle UWB signal, an indication of an amount of fuel the vehicle can receive, wherein, the fuel dispenser is authorized to dispense only the amount of fuel indicated in the vehicle UWB signal.

According to an aspect, a charger payment terminal, includes: an ultra-wideband transceiver; and a controller in communication with the ultra-wideband transceiver and with an electric charger, the controller being programmed to: receive, via the ultra-wideband transceiver, a vehicle UWB signal from a vehicle ultra-wideband transceiver disposed within a vehicle; determine from the vehicle UWB signal a location of the vehicle and a charge level associated with the vehicle; and authorize the electric charger to charge the vehicle at the charge level associated with the vehicle, based, at least in part, on whether the location of the vehicle is within a predetermined charging location.

In an example, the controller is further programmed to: monitor the location of the vehicle according to the vehicle UWB signal and to deauthorize the charging if the location of the vehicle changes.

In an example, the controller is further programmed to: receive, in the vehicle UWB signal, an indication of whether the vehicle motor is stopped or running and prompt a user to turn off the motor upon determining the motor is running.

In an example, prompting the user to turn off the motor comprises displaying a message on a screen visible to a user.

In an example, authorizing the electric charger to charge the vehicle is further based on receiving, in the vehicle UWB signal, the indication that the vehicle motor is stopped.

In an example, the controller is further programmed to: receive, in the vehicle UWB signal, an indication of the charge amount the vehicle can receive, wherein, the electric charger is authorized to provide only the charge amount indicated in the vehicle UWB signal.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the various embodiments.

FIG. 1 depicts a front view a dispenser with a UWB transceiver for determining the location and context of a vehicle, according to an example.

FIG. 2 depicts a block diagram of a payment terminal with a UWB transceiver for determining the location and context of a vehicle, according to an example.

FIG. 3A depicts a top view of a dispenser with a UWB transceiver in communication with a vehicle in approaching the dispenser, according to an example.

FIG. 3B depicts a top view of a dispenser with a UWB in communication with a vehicle in front of the dispenser, according to an example.

FIG. 3C depicts a top view of a dispenser with a UWB in communication with a vehicle leaving the dispenser, according to an example.

FIG. 4A depicts a flowchart of a partial method for conducting a transaction for fueling or charging a vehicle, using a UWB transceiver to locate and communicate with a UWB tag disposed on the vehicle, according to an example.

FIG. 4B depicts a flowchart of a partial method for conducting a transaction for fueling or charging a vehicle, using a UWB transceiver to locate and communicate with a UWB tag disposed on the vehicle, according to an example.

### DETAILED DESCRIPTION

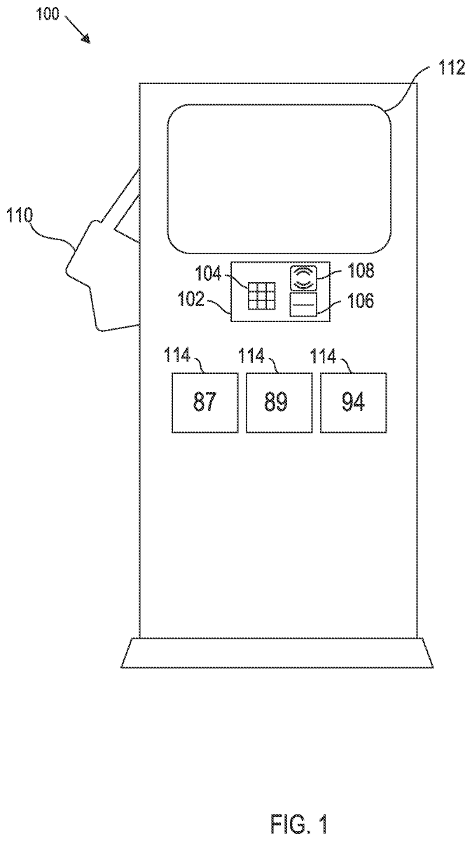

There is shown in FIG. 1 an example of a dispenser 100 equipped or otherwise associated with an ultra-wideband transceiver that can determine a location of a vehicle to be fueled or charged and receive data regarding the context of the vehicle from a UWB tag disposed on the vehicle. As shown in FIG. 1, dispenser 100 can include a payment terminal 102 for receiving payment information from a user, e.g., purchasing fuel at dispenser 100. As shown, payment terminal 102 can include a keypad 104, a card reader 106 (which can further include a transceiver or coil for receiving contactless payments), and at least one ultra-wideband transceiver 108 (in certain examples, dispenser 100 can include a plurality of spaced ultra-wideband transceivers 108). Dispenser 100 can further include a nozzle for dispensing fuel, a display 112, and buttons 114 for selecting a fuel grade. Further, while the example of dispenser 100 is shown as a fuel dispenser in FIG. 1, it should be understood that “dispenser,” as used in this disclosure, refers to any dispenser of fuel or of electrical charge. Stated differently, “dispenser,” refers to a dispenser of any fuel type (e.g., gasoline, diesel, hydrogen, etc.), or a charger for electric or plug-in hybrid vehicles. Thus, in certain examples, dispenser 100 can use a plug, rather than a nozzle, for delivering electric charge to the vehicle, as well as any suitable inputs for selecting charge type or beginning charging, as appropriate.

Except for ultra-wideband transceiver 108, and the use location and contextual information gathered from it, the operation of a payment terminal 102 and its constituent elements, such as keypad 104 and card reader 106 are generally known, and so will not be discussed in detail here. At a high level, however, payment terminal 102 can transmit and/or receive payment data via a network to and/or from a payment processor. For the purposes of this disclosure, payment terminal 102 communicating with a payment processor in an attempt to validate a payment is referred to as “processing” the payment (as this begins the payment processing). It should be understood that processing a payment can include communicating with the payment processor even if the payment processor ultimately denies the payment, because of insufficient funds, reaching a credit limit, etc. The payment terminal can communicate with the payment processor over any suitable network, such as a local area network (LAN), a wide area network (WAN), a 4G/LTE or 5G network, and which can include a plurality of devices and/or servers connected over the internet.

The payment processor can be a third-party processor, e.g., a party other than the user of the card, the business establishment, or the provider or the payment devices, that receives payment information from users and performs or handles the financial transaction between the source of funds of the user and the destination of the funds, e.g., the bank of the business establishment. Further, although payment terminal 102 is depicted with a card reader 106, any suitable method of receiving payment from a user besides payment cards can be used, including alternative payment methods such as PayPal, Stipe, Apple Pay, Alipay, Klarna, PaySafeCard, cryptocurrency, etc.

In addition to processing using a user's payment information, payment terminal 102 can authorize and deauthorize fueling or charging from dispenser 100. This can include activating a fuel pump or charger or sending a command to a controller or system that is responsible for controlling the activation of a fuel pump or a charger.

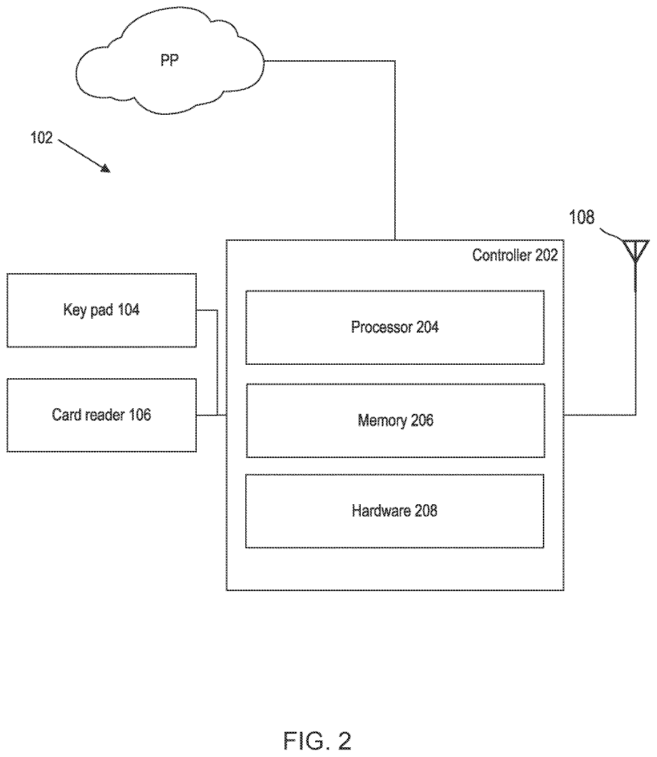

FIG. 2 depicts a simplified block diagram of an example payment terminal 102, focusing primarily on processing and components useful for completing the functions and methods described in this disclosure. As shown, payment terminal 102 includes UWB transceiver 108, keypad 104, card reader 106, and controller 202, comprising processor 204, memory 206, and any associated hardware 208. To focus more on the pertinent features of payment terminal 102, not shown in FIG. 7 are components for receiving payments via contactless payment method such NFC, components for connection to a network (although payment processing network PP is represented as a cloud in communication with controller 202), components for receiving power (e.g., a power supply), etc, which can be present in various examples of payment terminal 102.

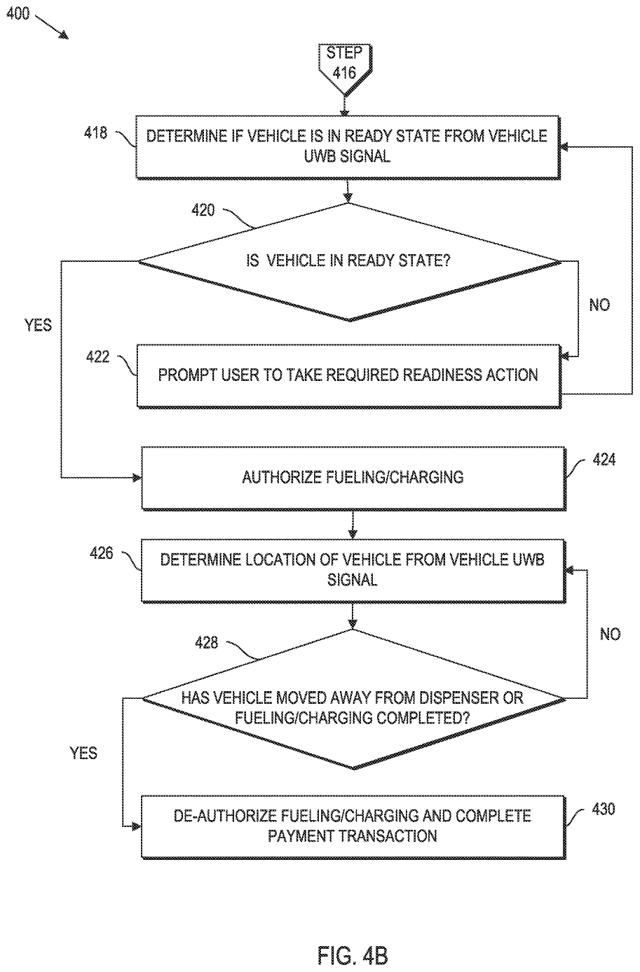

In various examples, controller 202 can include or more processors 204, together with any associated hardware 208, configured to execute at least one step (e.g., the steps described in connection with the method of FIG. 4) stored in a non-transitory storage medium, such as memory 206, to perform the various function described in this disclosure (e.g., receiving from UWB transceiver 108, determining whether vehicle is in location for fuel dispensing, etc.). For example, controller 202 can comprise a microprocessor or microcontroller executing steps stored in memory 206 (either as firmware or software). Further, as mentioned above, in various alternative examples, as described above, controller 202 can receive signals from multiple transceivers and/or encoded data from processors in communication with the one or more UWB transceivers 108. For the purposes of this disclosure, the encoded data from processors in communication with the transceiver 108 can be considered a signal from UWB transceiver 108.

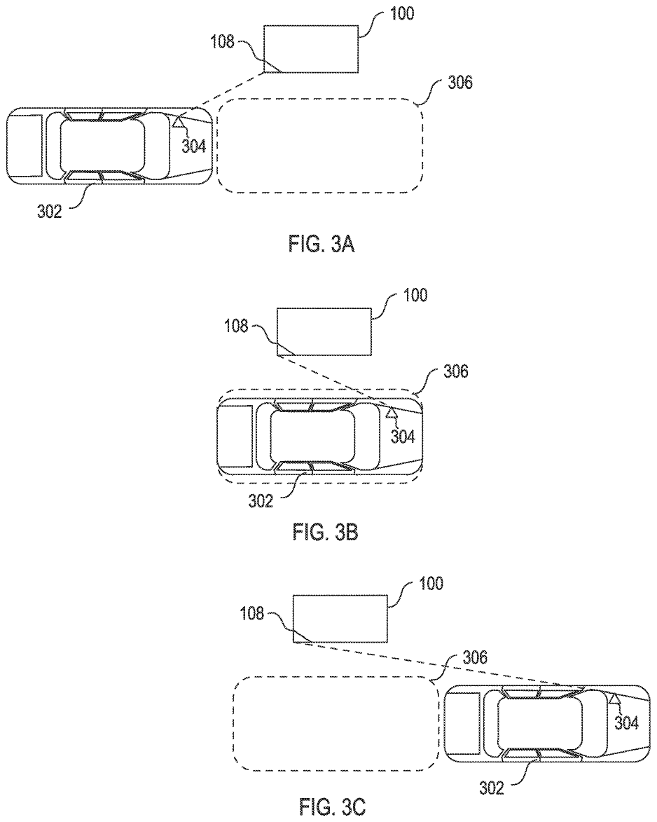

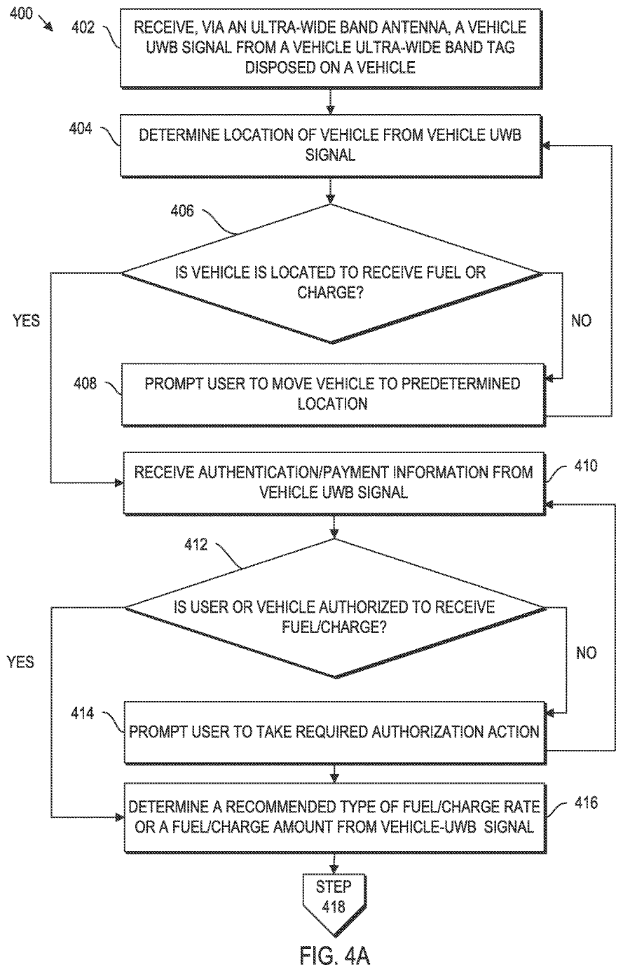

UWB transceiver 108 can be used to communicate to determine the location of a vehicle, the vehicle itself including a UWB tag in communication with UWB transceiver 108. This process is described in conjunction with FIGS. 3A-3C, which each depict a vehicle 302 including a UWB tag 304 as it drives up to and from dispenser 100. UWB tag 304 is disposed on vehicle 302, which the purposes of this disclosure, can refer to the placement of the UWB transceiver on the outside of the vehicle or within the vehicle. Further, in certain examples, the UWB transceiver need not be connected to the vehicle or otherwise installed at the time of manufacture but can instead be retrofitted by a user.

As shown, UWB transceiver 108 (which, being fixed in space, can be referred to as a UWB “anchor”) completes a ranging process with UWB tag 304 to determine the location of vehicle 302 with respect to dispenser 100. More particularly, the location of vehicle 302, as based on the signal received from UWB transceiver 108, can detect whether vehicle 302 is within a predetermined dispensing location 306. In this example, dispenser 100 can authorize fueling only after vehicle UWB tag 304 is detected within the predetermined dispensing location 306. In FIG. 3A, vehicle 302 is approaching dispenser 100, but not yet within the predetermined dispensing location. Accordingly, payment terminal 102 may not authorize fueling or charging of the vehicle. Instead, payment terminal 102 can issue a prompt, e.g., through message on display 112 or an audio cue played through a speaker associated with dispenser 100, or through a message sent via the UWB transceiver 108 to UWB tag 304 to be displayed on a screen within vehicle 304.

In FIG. 3B, vehicle 302 is within the predetermined dispensing location 306 and thus fueling or charging can be authorized by payment terminal 102 (provided that payment information is received and any other requirements for fueling or charging are satisfied). Further, before fueling or charging is authorized, the location of vehicle UWB tag 304 can be monitored to determine that the vehicle has stopped moving. While vehicle 302 is fueling or charging, the location of vehicle 302 can be monitored to determine whether it has moved. If the vehicle moves during charging, e.g., some predetermined distance (which can include any distance greater than 0 cm) or out of the predetermined dispensing location, fueling or charging can be deauthorized. Thus, even if the user did not return the nozzle of dispenser 110 to its base, once the vehicle has exited the predetermined dispensing location, as shown in FIG. 3C (or otherwise moved some predetermined distance from its initial fueling/dispensing location), further fueling or charging is deauthorized, preventing a later user to fuel or charge at the first user's expense or using the first user's membership discount with a particular merchant.

As shown, predetermined dispensing location 306 can be a designated location in front of dispenser 100. The shape and location of predetermined dispensing location 306 can depend upon the nature and context of dispenser 100, e.g., the length nozzle/plug can reach in front of dispenser 100, the proximity to other dispensers in the area, etc. In alternative examples, the predetermined dispensing location can more simply be a predetermined distance from UWB transceiver 108 (i.e., a range); however, it is generally more desirable to accurately designate a location where the vehicle can be fueled or charged in front of dispenser 100.

The process of determining the location of a UWB tag is generally understood, and any suitable method can be used. Generally speaking, the location of UWB tag 304 can be determined using a ranging algorithm that leverages measurements of signals transmitted between the UWB transceiver and tag, such as time-of-flight (ToF). The ToF calculation can be calculated according to one-way ranging—i.e., the ToF is calculated from a single challenge packet and response packet-or, in alternative examples, two-way ranging, in which the device initially sending the challenge packet, itself responds to the response packet. The six timestamps generated from the two-way ranging methods can be used to further resolve any ambiguities introduced from unsynchronized oscillators in the devices.

It should be understood that range simply refers the distance between UWB transceiver 108 and vehicle UWB tag 304—it does not refer to the precise location of the vehicle UWB tag 304, which is typically expressed as a set of coordinates in some known space. (Although range is considered one method of determining whether the vehicle is within the predetermined dispensing location.) Further, while the one-way ranging and two-ranging are provided as examples, it should be understood that any suitable method of determining range between the two devices can be used.

In an alternative example, instead of simply determining range between the devices, the location can be determined. The location of vehicle UWB tag 304 can be determined using a plurality of transceivers 108, in a mutually spaced arrangement, that each perform ranging (e.g., one-way or two-way ranging) and the location of the UWB tag can be triangulated, according to the determined ranges. (This method is also referred to as time-difference of arrival.) In an example, this can be accomplished by employing timestamps, respectively received from each of a plurality of transceivers 108, to determine the range from the vehicle UWB tag 304 to the respective UWB transceiver 108 of the plurality of transceivers. From these ranges, a controller (e. g, controller 202), programmed to perform a multilateration algorithm, can determine the location of the UWB tag relative to the transceivers 108. While, generally, three or more transceivers performing ranging are required to unambiguously determine the location of vehicle UWB tag 304, in an alternative example, only two transceivers can be used, if some ambiguity is tolerable.

The plurality of UWB transceivers 108 can suitably housed within payment terminal 102 or dispenser 100. Alternatively, each dispenser can house a single UWB transceiver 108, but a plurality of dispensers 100 can be deployed within a filing or charging station, the signals from each UWB transceiver 108 being collected used in concert to perform the time-difference of arrival method or method for determining the location of a given vehicle UWB tag 304. In yet another example, the UWB transceivers 108 can disposed about the charging or filling station and not housed within a given dispenser 100 or payment terminal 102. In this example, the signals from the UWB transceivers 108 can be delivered to each payment terminal 102 for calculating the location of a vehicle UWB tag 304. Alternatively, the signals from the UWB transceivers 108 disposed about the charging or filling station can be delivered to a signal controller responsible for detecting the location of the vehicle UWB tag 304 and this location can be delivered to each payment terminal 102, e.g., as a set of coordinates.

In various alternatives, other suitable ways of determining range or location are contemplated. For example, phase difference of arrival to can be used to determine both range and bearing. This example is accomplished by measuring the phase difference at two transceivers (e.g., included in UWB tag or included in UWB transceiver) to determine to angle of arrival of the challenge packet or other signal.

The use of a UWB transceiver and tag permits location detection that is more than simply detecting the presence of a compliant signal. For example, near-field communication devices, which are typically passive tags that respond to an interrogating signal through mutual magnetic coupling, do not provide any information of the range or location of the tag with respect to the interrogating device. Although certain types of tags (e.g., NFC) only work within a known range, this information cannot be understood to comprise a range or location. Rather the operating bandwidth of UWB permits the location detection with sufficient accuracy that the payment terminal and methods described in this disclosure can be accomplished with satisfactory security.

In addition to detecting a range or location of a vehicle UWB tag, the UWB transceiver(s) 108 can be employed to receive and send information from and to the vehicle UWB tag. The information can include, for example, status information regarding the context of the vehicle. Such information can comprise payment information, user account information, fuel type or charging rate of vehicle, whether the vehicle is turned OFF or is otherwise in a state to receive fuel or a charge. This information can be used to pre-authorize payment of the fueling or charging, via payment information received over the UWB channel between the vehicle UWB tag 304 and the UWB transceiver 108 or to check the membership or account status associated with the vehicle, if the merchant offers rewards programs, discounts, or fueling or charging for members only. This information can also be used to preset the fuel or charging type. These features and others will be described below in connection with the flowcharts of FIGS. 4A-4B.

FIGS. 4A-4B depicts a flowchart of a method 400 for completing a transaction for fuel or charging of a vehicle, using a UWB transceiver to communicate with a UWB tag disposed on a vehicle. The UWB transceiver in communication with the vehicle UWB tag can, as described in connection with FIGS. 1-3 can comprise multiple transceivers disposed at locations suitable for detecting the vehicle UWB tag and performing the necessary ranging and communicating. Thus, in one example, the one or more UWB transceiver can be disposed on the dispenser or can otherwise be disposed about the fueling/charger, the signals from which being received by a controller. The controller can comprise a one or more processors executing commands stored in one or more non-transitory storage media to execute at the steps of method 400. The controller can be in communication with or a fuel pump or a system or controller for managing a fuel pump or a charger or system for managing a charger so that it the controller can effectively authorize or deauthorize fueling or charging, as appropriate.

Turning now to the steps of method 400, at step 402 a vehicle UWB signal is received from a vehicle ultra-wideband transceiver disposed on a vehicle. The vehicle UWB signal is received via the associated ultra-wideband transceiver. The vehicle UWB signal, for the purposes of this disclosure, is the ultra-wideband transceiver signal received from the vehicle and used, in various examples, for the purposes of determining the vehicle's location (as described, for example, in connection with steps 404 and 426) and other information regarding the status of the vehicle or transaction (as described, for example, in connection with steps 410, 416, and 418). Accordingly, the nature and information communicated within the vehicle UWB signal can change over the course of method 400 to account for the needs of the given step.

At step 404, the location of vehicle is determined from the received vehicle UWB signal. The location of the vehicle can be determined by completing ranging between one or more UWB transceivers associated with the payment terminal and the vehicle UWB tag. Ranging accomplished with a single UWB transceiver is sufficient to determine a range from the UWB transceiver. Ranging accomplished with multiple UWB transceivers can be used to determine the location of the vehicle UWB tag. The one or more UWB transceivers (e.g., as disposed within UWB transceivers) can be disposed within the payment terminal or within the dispenser or otherwise disposed, as suitable, about the filling or charging station. Ranging and determining the location of a UWB tag is generally known in the art and any suitable method, such as those described in connection with FIG. 3, can be used.

Step 406 is a decision block that represents the result of determining whether the vehicle is located to receive fuel or a charge. This step can comprise determining whether the vehicle is within a predetermined dispensing location, which can be a predetermined distance of the dispenser, or, alternatively, within a predetermined zone in front of otherwise about the dispenser. If the vehicle is located to receive fuel or a charge, the method can proceed to step 410, otherwise, the method can proceed to step 408 to prompt the user to move closer the dispenser. The prompt can, for example, be a message displayed on the screen of the dispenser or an audio cue that is played from speakers located on the dispenser. Alternatively, the prompt can be a message transmitted, via the UWB transceiver, or other suitable wireless protocol, to the vehicle for display on a screen within the vehicle. Once the prompt occurs at step 408, the method returns to step 404 to again determine the location of the vehicle from the vehicle UWB signal. Steps 404-408 thus define a loop that occurs until the vehicle is in the proper location to receive fuel or charge. In certain examples, step 408 can be omitted, or can occur at only certain intervals while steps 404-408 are looped.

At step 410, payment and/or authentication information is received from the vehicle UWB signal. In certain examples, payment information can be transmitted in the vehicle UWB signal to begin the payment transaction without requiring the user to otherwise provide a payment instrument. Alternatively, payment information can be account information for an Alternative Payment Method provider (such as PayPal, AliPay, Venmo, Zelle etc.), as required by such providers. Because the transaction cannot be completed until the amount of fuel or charge that the vehicle has received has been calculated, the payment transaction is not completed (i.e., processed) until step 430, discussed below.

In certain examples, extra security measures can be implemented to ensure that the payment details are not transmitted without authorization from the user. For example, the user can be prompted, on the user's mobile device to permit payment details to be transmitted. The prompt can require certain biometric inputs, as are typical on mobile devices, such as face or fingerprint recognition. Further, in certain examples, payment details are not stored within the vehicle itself, but instead relayed from the user's mobile device. Thus, in this example, the user's mobile device interacts only with the user's vehicle, which acts an intermediary between the user's mobile device and the dispenser. Alternatively, the prompt can appear on, for example, a touch screen located within the vehicle.

In alternative examples, the user's payment details can be stored at a remote server, e.g., owned by the merchant, and associated with a unique identifier assigned to the vehicle and transmitted with the vehicle UWB signal. In this example, the unique identifier can be passed, via an internet connection, to the remote server, which can retrieve the user's payment details associated with the identifier and initiate the transaction. The remote server can then pass a confirmation back to the payment terminal that the payment details have been successfully accessed.

Of course, in alternative examples, rather than transmitting payment details via the vehicle UWB signal, the user can enter payment details according to traditional methods, such as entering a payment card, or paying inside the station.

At step 410, any authentication information can be further received from the vehicle UWB signal Authentication information comprises a user account identifier that can be provided for the dispenser. Thus, if the user has a rewards account that provides rewards for using a particular merchant's dispenser, or which authorizes the user to use the merchant's dispenser, those account details can be provided via the vehicle UWB signal. If the user has prepaid for any amount of fuel or charge, the user's account and prepayment can be accessed through the user's account (alternatively, the account can be tied to a particular payment method, the details of which can also be received in step 410). In various examples, the user account identifier can be a user account number, a username, a unique token, or any other suitable identifier.

Like the payment details, the user's account information, including whether the account associated with a rewards program or is authorized to receive fuel or a charge, can alternatively be associated with the vehicle's unique identifier. Thus, when the identifier is received, the identifier can be passed to the remote server and associated with the user's account details. The remote server can then pass a confirmation that the account details have been successfully accessed, and whether those details provide the user with a particular rate for fuel or charging, or whether the user is authorized to use the dispenser, can be included in the information received from the server.

Step 412 is a decision block that represents whether the vehicle is authorized to receive fuel or a charge. This step determines whether the payment details and any necessary account status have been satisfactorily received in step 410. If the vehicle is authorized to receive a charge method 400 can proceed to step 416. If the vehicle, however, is not authorized to receive fuel or a charge, method 400 can proceed to step 414, where the user is prompted to take a required authorization action. The required authorization action can be, for example, entering payment details (which can be transmitted via the vehicle UWB signal or entered through another means), or updating the user's account information to authorize the user to receive fuel or a charge at the dispenser.

At step 416, a recommended type of fuel/charge rate is identified from vehicle UWB signal. For example, certain vehicle engines are configured to receive a certain fuel grade (e.g., 87, 89, or 93 octane fuel) or a certain charge power output (e.g., 19 kKW or 350 kW), which corresponds to the rate at which the battery charges. This information can be passed directly to the dispenser via the vehicle UWB signal; however, in alternative examples, other information can be passed that permits the dispenser to retrieve the correct fuel type or charge rate. For example, data representative of the vehicle's make and model can be passed via the vehicle UWB signal. The dispenser can then input the make and model to a look up table (stored locally or at a remote server) to determine the recommended fuel type or charge rate. Alternatively, the recommended fuel type or charge rate, or the vehicle's make and model can be associated with a user's account information and accessed in as part of step 410. Additionally, the amount of fuel or charge that the vehicle can presently receive can be received via the vehicle UWB signal. This can, particularly in the fueling context, permit the dispenser to stop fueling when the limit is reached to avoid fuel spillage. Once the fuel type or the charge rate have been determined, the correct fuel type or charge rate can be preset for when fueling/charging begins. The preset value of the fuel type or charge rate can be adjusted, however, through an additional user input, entered, for example, through a button, touchscreen, or other input on the dispenser, or via an additional user input received from the vehicle UWB signal or the user's mobile device.

At step 418, it is determined if vehicle is in ready state from vehicle UWB signal. This step can include ensuring that a vehicle is in an OFF state (i.e., the engine or motor(s)) prior to fueling or charging. The status of the vehicle, as being in an ON or OFF state, can be received from the vehicle UWB signal. Certain types of vehicles, such as electric vehicles, may not require that the vehicle be turned OFF prior to charge. These vehicles, however, might require that other steps be accomplished, such as the vehicle being placed into park or other mode for receiving a charge. Thus, in certain examples, the information passed to the dispenser that an internal check of vehicle's readiness to receive fuel or a charge have been completed. This step can also include determining whether the vehicle is stationary. While determining that the vehicle is OFF or otherwise in a state to receive fuel or a charge typically ensures that the vehicle is also stationary, it is possible that the vehicle engine could be OFF but the vehicle placed in neutral or the parking brake not correctly applied. Accordingly, step 418 can repeat step 404 to determine if the vehicle has moved over some predetermined period of time (e.g., 3-5 seconds).

Step 420 is a decision block that represents the determination of whether the vehicle is in the ready state at step 418. If the vehicle is in the ready state, the method can proceed to step 424. Otherwise, the user can be prompted, at step 422 to take the required action to place the vehicle in a ready state (i.e., a readiness action). Depending on the needs of the particular vehicle, this can include placing the vehicle into park or turning the engine OFF. The prompt can, for example, be a message displayed on the screen of the dispenser or an audio cue that is played from speakers located on the dispenser. Alternatively, the prompt can be a message transmitted, via the UWB transceiver, or other suitable wireless protocol, to the vehicle for display on a screen within the vehicle. Once the prompt has been played, the method can return to step 418 to determine if the correct readiness action has been taken.

At step 424, the charging or fueling can be authorized. This step can comprise sending a command to a controller within dispenser or other system responsible for initiating fueling or charging.

During the fueling or charging processor at steps 426-428, the location of the vehicle can be monitored. To prevent a user from moving the vehicle without terminating the transaction and turning off the fuel pump or charger, the location of the vehicle can be determined at 426.

At step 428, it is determined whether the vehicle has moved away from the dispenser or if fueling/charging has otherwise been completed by, for example, returning the nozzle or connector to the dispenser. If the vehicle, at step 426, has moved, the transaction can be terminated and the fueling/charging deauthorized (i.e., stopped). Generally, vehicles should be OFF and completely stationary during the fueling or charging process, so any movement during the fueling/charging process can terminate fueling or charging. However, in certain examples, it may be permissible to move the vehicle some predetermined distance or it may be permissible to continue fueling or charging as long as the vehicle remains in the predetermined fueling or charging location.

At step 430, fueling or charging has been completed (e.g., the nozzle has been returned to the dispenser or the amount of fuel determined in step 416 has been dispensed), or the vehicle has moved before the fueling or charging has been completed, thus the pump or charger is deauthorized and the payment transaction is completed according to the amount of fuel or charge that the vehicle received.

Method 400 describes a set of inventive features that adopt and make use of advantages provided a UWB transceiver disposed within a vehicle. It is not necessary that each feature be employed in each example. Indeed, in certain examples, some combinations may omit certain features, and thus certain steps, of method 400. Further, it is not strictly necessary that some of the steps occur in the order listed in method 400. For example, since steps 404-408 and 410-414 can be preconditions for authorizing fueling or charging, the ordering steps can be reversed: thus, steps 410-414, which relate to determining if the user or vehicle is authorized to receive fuel or charge can occur before the vehicle is necessarily in position to receive the fuel or charge as determined in steps 404-408. Further, while certain steps are depicted as occurring sequentially, various steps can occur concurrently or in an interleaved manner. For example, while steps 404-408 are looping, waiting for the vehicle to enter the location for fueling or charging, steps 410-414 can occur to receive payment or authorization or prompt the user to do so. These loops can thus occur simultaneously until both are completed and the method can proceed.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.” The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

The above-described examples of the described subject matter can be implemented in any of numerous ways. For example, some aspects may be implemented using hardware, software or a combination thereof. When any aspect is implemented at least in part in software, the software code can be executed on any suitable processor or collection of processors, whether provided in a single device or computer or distributed among multiple devices/computers.

The present disclosure may be implemented as a system, a method, and/or a computer program product at any possible technical detail level of integration. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some examples, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to examples of the disclosure. It will be understood that each block of the flowchart illustrations and/or block diagrams, and combinations of blocks in the flowchart illustrations and/or block diagrams, can be implemented by computer readable program instructions.

The computer readable program instructions may be provided to a processor of a, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various examples of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Other implementations are within the scope of the following claims and other claims to which the applicant may be entitled.

While various examples have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the examples described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific examples described herein. It is, therefore, to be understood that the foregoing examples are presented by way of example only and that, within the scope of the appended claims and equivalents thereto, examples may be practiced otherwise than as specifically described and claimed. Examples of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

1. A fuel dispenser payment terminal, comprising:
an ultra-wideband transceiver; and
a controller in communication with the ultra-wideband transceiver and with a fuel dispenser, the controller being programmed to:
receive, via the ultra-wideband transceiver, a vehicle UWB signal from a vehicle ultra-wideband tag disposed on a vehicle;
determine from the vehicle UWB signal a location of the vehicle and a fuel type associated with the vehicle;
authorize the fuel dispenser to dispense the fuel type associated with the vehicle, based, at least in part, on whether the location of the vehicle is within a predetermined fueling location; and
monitor the location of the vehicle according to the vehicle UWB signal and to deauthorize the fuel dispenser if the location of the vehicle changes.

2. (canceled)

3. The fuel dispenser payment terminal of claim 1, wherein authorizing the fuel dispenser to dispense the fuel type associated with the vehicle is further based on determining whether the vehicle UWB signal is associated with a user authorized to receive fuel from the fuel dispenser.

4. The fuel dispenser payment terminal of claim 1, wherein authorizing the fuel dispenser to dispense the fuel type associated with the vehicle is further based on receiving payment information in the vehicle UWB signal.

5. The fuel dispenser payment terminal of claim 1, wherein authorizing the fuel dispenser to dispense the fuel type associated with the vehicle is further based on receiving payment information from a user.

6. The fuel dispenser payment terminal of claim 1, wherein determining from the vehicle UWB signal a fuel type associated with the vehicle comprises determining from the vehicle UWB signal a vehicle type encoded in the vehicle UWB signal, sending the vehicle type to a remote server, and receiving, from the remote server, the fuel type associated with the vehicle.

7. The fuel dispenser payment terminal of claim 1, wherein the controller is further programmed to: receive, in the vehicle UWB signal, an indication of whether the vehicle engine is stopped or running and prompt a user to turn off the engine if the engine is running.

8. The fuel dispenser payment terminal of claim 7, wherein prompting the user to turn off the engine comprises displaying a message on a screen visible to a user.

9. The fuel dispenser payment terminal of claim 7, wherein authorizing the fuel dispenser to dispense the fuel type associated with the vehicle is further based on receiving, in the vehicle UWB signal, the indication that the vehicle engine is stopped.

10. The fuel dispenser payment terminal of claim 1, wherein the controller is further programmed to: receive, in the vehicle UWB signal, an indication of an amount of fuel the vehicle can receive, wherein, the fuel dispenser is authorized to dispense only the amount of fuel indicated in the vehicle UWB signal.

11. A method for authorizing fuel dispensation, comprising:
receiving, via an ultra-wideband transceiver, a vehicle UWB signal from a vehicle ultra-wideband transceiver disposed within a vehicle;
determining from the vehicle UWB signal a location of the vehicle and a fuel type associated with the vehicle;
authorizing a fuel dispenser to dispense the fuel type associated with the vehicle, based, at least in part, on whether the location of the vehicle is within a predetermined fueling location; and
monitoring the location of the vehicle according to the vehicle UWB signal and to deauthorize the fuel dispenser if the location of the vehicle changes.

12. (canceled)

13. The method for authorizing fuel dispensation of claim 11, wherein authorizing the fuel dispenser to dispense the fuel type associated with the vehicle is further based on determining whether the vehicle UWB signal is associated with a user authorized to receive fuel from the fuel dispenser.

14. The method for authorizing fuel dispensation of claim 11, wherein authorizing the fuel dispenser to dispense the fuel type associated with the vehicle is further based on receiving payment information in the vehicle UWB signal.

15. The method for authorizing fuel dispensation of claim 11, wherein authorizing the fuel dispenser to dispense the fuel type associated with the vehicle is further based on receiving payment information from a user.

16. The method for authorizing fuel dispensation of claim 11, wherein determining from the vehicle UWB signal a fuel type associated with the vehicle comprises determining from the vehicle UWB signal a vehicle type encoded in the vehicle UWB signal, sending the vehicle type to a remote server, and receiving, from the remote server, the fuel type associated with the vehicle.

17. The method for authorizing fuel dispensation of claim 11, further comprising: receiving, in the vehicle UWB signal, an indication of whether the vehicle engine is stopped or running and prompting a user to turn off the engine upon determining the engine is running.

18. The method for authorizing fuel dispensation of claim 17, wherein prompting the user to turn off the engine comprises displaying a message on a screen visible to a user.

19. The method for authorizing fuel dispensation of claim 17, wherein authorizing the fuel dispenser to dispense the fuel type associated with the vehicle is further based on receiving, in the vehicle UWB signal, the indication that the vehicle engine is stopped.

20. The method for authorizing fuel dispensation of claim 11, further comprising: receiving, in the vehicle UWB signal, an indication of an amount of fuel the vehicle can receive, wherein, the fuel dispenser is authorized to dispense only the amount of fuel indicated in the vehicle UWB signal.

21. A charger payment terminal, comprising:
an ultra-wideband transceiver; and
a controller in communication with the ultra-wideband transceiver and with an electric charger, the controller being programmed to:
receive, via the ultra-wideband transceiver, a vehicle UWB signal from a vehicle ultra-wideband transceiver disposed within a vehicle;
determine from the vehicle UWB signal a location of the vehicle and a charge level associated with the vehicle;
authorize the electric charger to charge the vehicle at the charge level associated with the vehicle, based, at least in part, on whether the location of the vehicle is within a predetermined charging location; and
monitor the location of the vehicle according to the vehicle UWB signal and to deauthorize the charging if the location of the vehicle changes.

22. (canceled)

23. The charger payment terminal of claim 21, wherein the controller is further programmed to: receive, in the vehicle UWB signal, an indication of whether the vehicle motor is stopped or running and prompt a user to turn off the motor upon determining the motor is running.

24. The charger payment terminal of claim 23, wherein prompting the user to turn off the motor comprises displaying a message on a screen visible to a user.

25. The charger payment terminal of claim 23, wherein authorizing the electric charger to charge the vehicle is further based on receiving, in the vehicle UWB signal, the indication that the vehicle motor is stopped.

26. The charger payment terminal of claim 21, wherein the controller is further programmed to: receive, in the vehicle UWB signal, an indication of the charge amount the vehicle can receive, wherein, the electric charger is authorized to provide only the charge amount indicated in the vehicle UWB signal.
